(19) United States
(12) Patent Application Publication
(10) Pub. No.: US 2023/0080235 A1
(43) Pub. Date: Mar. 16, 2023

(54) ADAPTING MODELS FOR ARTIFICIAL INTELLIGENCE

(71) Applicant: Nokia Technologies OY, Espoo (FI)

(72) Inventors: Alberto GIL RAMOS, Cambridge Cambridgeshire (GB); Dmitry KAZHDAN, Cambridge Cambridgeshire (GB); Fahim KAWSAR, Cambridge Cambridgeshire (GB)

(21) Appl. No.: 17/760,311

(22) PCT Filed: Feb. 1, 2021
(86) PCT No.: PCT/FI2021/050064

§ 371 Date: Aug. 8, 2022

(30) Foreign Application Priority Data
Feb. 14, 2020 (GB) 2002023.6

(51) Int. Cl. G06N 20/00; G06N 7/00

(52) U.S. Cl. CPC G06N 20/00; G06N 7/005

(57) ABSTRACT

Adapting Models for Artificial Intelligence An apparatus and method is disclosed, the apparatus comprising means for providing a first machine learning model for classifying first input data to one of a first number of classes, for receiving an input indicative of one or more new classes to add to the first machine learning model and for receiving second input data for allocating to the or each new class. The means may be configured to adapt the first machine learning model to provide a second machine learning model by adding the one or more new classes to the first number of classes and to train the second machine learning model using the first input data and the second input data.

### FIELD

Example embodiments relate to an apparatus, method and computer program for adapting models for artificial intelligence (AI) applications, systems and methods.

### BACKGROUND

Artificial Intelligence (AI) systems are becoming widespread. For example, user-centred sensory AI systems such as personal assistants, wearables and smart home devices are increasing in popularity and there is an interest in offering more personalised services tailored to the needs of individuals or small groups of individuals. Such AI systems may comprise storing of a computational machine learning (ML) model to perform a given task. ML may comprise a learning phase and an implementation engine to perform inferences, for example to match an input, such as sensory data, to a class. A basic example is word recognition, whereby the ML model may be trained to take a user's speech as input and to classify segments of the speech to one of a plurality of labelled word classes. Another example is identifying a user's activity, such as walking, running or cycling.

### SUMMARY

The scope of protection sought for various example embodiments of the invention is set out by the independent claims. The embodiments and features, if any, described in this specification that do not fall under the scope of the independent claims are to be interpreted as examples useful for understanding various embodiments of the invention.

According to a first aspect, this specification describes an apparatus, comprising means for: providing a first machine learning model for classifying first input data to one of a first number of classes; receiving an input indicative of one or more new classes to add to the first machine learning model; receiving second input data for allocating to the or each new class; adapting the first machine learning model to provide a second machine learning model by adding the one or more new classes to the first number of classes; and training the second machine learning model using the first input data and the second input data.

The adapting means may be further configured for: setting a prior probability distribution for the second machine learning model based on (i) a first posterior probability distribution learned for the first number of classes, and (ii) one or more outputs generated by the second machine learning model responsive to receiving the first input data; and updating the second machine learning model by means of applying the first input data and the second input data as training data.

The means for setting the prior probability distribution for the second machine learning model may be configured for providing a Gaussian probability distribution with: (i) a mean substantially equal to the mean of the first posterior probability distribution, and (ii) a precision matrix.

The precision matrix may comprise parameters based on derivatives of an expectation of the one or more outputs generated by the second machine learning model, wherein the expectation is with respect to the first posterior probability distribution.

The adapting means may be configured for: providing a second posterior distribution, wherein the second posterior distribution comprises a product of mixtures of Gaussian distributions, each Gaussian distribution having the same covariance matrix; and training the second machine learning model based on a loss function comprising a supervised loss, wherein the supervised loss minimises an upper bound of a divergence between the prior distribution and the second posterior distribution.

The apparatus may further comprise means for: determining that received first input data is either labelled or unlabelled data based on a confidence level associated with the resulting output from its application to the first machine learning model; and storing the unlabelled first input data.

The apparatus may further comprise means for: receiving user-labelling of at least a portion of the stored unlabelled first data as belonging to a particular class of the second machine learning model; and adapting the second machine learning model by means of applying the user-labelled data to it as new training data.

The apparatus may further comprise means for prompting said user-labelling via a user-interface of the apparatus.

The apparatus may further comprise means for identifying, from the stored unlabelled first data, a portion of said data having the highest likelihood of belonging to a particular class.

The adapting means may comprise: receiving one or more unlabelled data values from the stored unlabelled first data; identifying one or more semantically-similar data points to the one or more unlabelled data values; applying the second machine learning model to (i) the one or more unlabelled data values to generate an unlabelled model output, and (ii) the identified one or more semantically-similar data points to generate a semantically-similar model output; and training the second machine learning model based on a loss function comprising an unsupervised training loss, wherein the unsupervised training loss is arranged to minimise an averaged divergence between: (i) the unlabelled model output, and (ii) the semantically-similar model output.

The first and second input data may be generated by one or more sensors provided on said apparatus and/or on one or more user devices associated or paired with said apparatus as part of a personal network of an individual user.

One or more of said apparatus and/or the one or more user devices may include wearable device(s).

None of the first and second input data may be received externally from the apparatus and/or from the one or more user devices associated or paired with said apparatus as part of the personal network.

The first and second machine learning models may be trained to classify input data representing user motion to one of a plurality of the different classes representing respective activities.

The first and second machine learning models may be trained to classify input data representing audio to one of a plurality of the different classes representing users or commands.

According to a second aspect, this specification describes a method, comprising: providing a first machine learning model for classifying first input data to one of a first number of classes; receiving an input indicative of one or more new classes to add to the first machine learning model; receiving second input data for allocating to the or each new class; adapting the first machine learning model to provide a second machine learning model by adding the one or more new classes to the first number of classes; and training the second machine learning model using the first input data and the second input data.

The adapting may comprise setting a prior probability distribution for the second machine learning model based on (i) a first posterior probability distribution learned for the first number of classes, and (ii) one or more outputs generated by the second machine learning model responsive to receiving the first input data; and updating the second machine learning model by means of applying the first input data and the second input data as training data. Setting the prior probability distribution for the second machine learning model may comprise providing a Gaussian probability distribution with: (i) a mean substantially equal to the mean of the first posterior probability distribution, and (ii) a precision matrix. The precision matrix may comprise parameters based on derivatives of an expectation of the one or more outputs generated by the second machine learning model, wherein the expectation is with respect to the first posterior probability distribution. The adapting may comprise: providing a second posterior distribution, wherein the second posterior distribution comprises a product of mixtures of Gaussian distributions, each Gaussian distribution having the same covariance matrix; and training the second machine learning model based on a loss function comprising a supervised loss, wherein the supervised loss minimises an upper bound of a divergence between the prior distribution and the second posterior distribution. The method may further comprise: determining that received first input data is either labelled or unlabelled data based on a confidence level associated with the resulting output from its application to the first machine learning model; and storing the unlabelled first input data. The method may further comprise: receiving user-labelling of at least a portion of the stored unlabelled first data as belonging to a particular class of the second machine learning model; and adapting the second machine learning model by means of applying the user-labelled data to it as new training data. The method may further comprise prompting said user-labelling via a user-interface of the apparatus. The method may further comprise identifying, from the stored unlabelled first data, a portion of said data having the highest likelihood of belonging to a particular class. The adapting may comprise: receiving one or more unlabelled data values from the stored unlabelled first data; identifying one or more semantically-similar data points to the one or more unlabelled data values; applying the second machine learning model to (i) the one or more unlabelled data values to generate an unlabelled model output, and (ii) the identified one or more semantically-similar data points to generate a semantically-similar model output; and training the second machine learning model based on a loss function comprising an unsupervised training loss, wherein the unsupervised training loss is arranged to minimise an averaged divergence between: (i) the unlabelled model output, and (ii) the semantically-similar model output. The first and second input data may be generated by one or more sensors provided on said apparatus and/or on one or more user devices associated or paired with said apparatus as part of a personal network of an individual user. One or more of said apparatus and/or the one or more user devices may include wearable device(s). The first and second machine learning models may be trained to classify input data representing user motion to one of a plurality of the different classes representing respective activities. The first and second machine learning models may be trained to classify input data representing audio to one of a plurality of the different classes representing users or commands.

According to a third aspect, this specification describes computer-readable instructions which, when executed by computing apparatus, cause the computing apparatus to perform a method, comprising at least some of the features of the second aspect.

According to a fourth aspect, this specification describes a computer-readable medium comprising program instructions stored thereon for performing a method, comprising at least some of the features of the second aspect

According to a fifth aspect, this specification describes an apparatus comprising: at least one processor; and at least one memory including computer program code which, when executed by the at least one processor, causes the apparatus to perform a method, comprising at least some of the features of the second aspect

### DESCRIPTION OF DRAWINGS

Example embodiments will now be described, by way of non-limiting example, with reference to the accompanying drawings, in which:

FIG. 1 is a schematic view of functional elements of a system which may be configured with means for adapting a machine learning model according to one or more example embodiments;

FIGS. 2A-2C are representational views, respectively showing the addition of classes to an adaptable machine learning model according to one or more example embodiments;

FIG. 3 is a schematic view of functional components of a user device for adapting a machine learning model according to one or more example embodiments;

FIGS. 4A-4D are schematic views, similar to FIG. 3, showing respective stages of operation of the user device;

FIGS. 5A-5C are schematic views showing how a machine learning model may be trained in accordance with a loss function according to one or more example embodiments;

FIG. 6 is a schematic view showing an overview of data interactions according to one or more example embodiments;

FIG. 7 is a flow diagram showing processing operations that may be performed according to one or more example embodiments; and

FIG. 8 is a functional block diagram of an apparatus configured to perform the operations described herein, for example those described with reference to FIG. 7.

### DETAILED DESCRIPTION

Example embodiments relate to apparatuses, systems and methods for providing at least part of the functionality of a machine learning (ML) apparatus. The term machine learning may be considered a subset of the Artificial Intelligence (AI). Machine learning generally involves the use of computational models and/or algorithms for performing a specific task without using explicit instructions. Example applications include classification, clustering, regression and dimensionality reduction, although example embodiments are not limited to any particular model or application.

Artificial neural networks, more commonly referred to as neural networks, are a class of machine learning algorithm used to model patterns in datasets using a topology comprising, for example, an input layer, an output layer and one or more hidden layers in-between said input and output layers, which may use a non-linear activation function (AF) and possibly a bias. After training the neural network, which may involve supervised or unsupervised learning, in an inference phase, the neural network takes input, passes it through the one or more hidden layers, each comprising multiple trained nodes or “neurons”, and may output, for example, a prediction representing the combined input of the neurons. Training of the neural network may be performed iteratively, for example using an optimization technique such as gradient descent.

Example embodiments relate to apparatuses, systems and methods for adapting, i.e. extending, a computational machine learning model (hereafter “model”), which may include adding one or more output classes to the one or more classes already provided. One motivation for this is that, as mentioned, user-facing machine learning systems are becoming widespread. Examples include the use of machine learning in smartphones, personal assistants, smart home devices, wearable devices and Internet-of-Things (IoT) devices. Development of such systems is challenging because different users have different needs and these needs can change over time. For example, a user that wishes to track and have analysed their physical activities (e.g. running and cycling) may rely on a first model, downloaded or provided to a personal device. If that user wishes to add a new activity at some point, later-on (e.g. swimming), then they typically would have to download another model, if one is available, which ultimately involves processing, download bandwidth and the existence of a network connection to facilitate the download. For example, a user may wish to add another person or voice to a personal assistant in their home.

Example embodiments obviate the need to anticipate and provide fresh models for the potentially limitless number of extensions to existing models that users may require at some time in the future. Example embodiments also enable provision of extended models locally, largely or entirely confined to their personal apparatus and/or a personal network comprising a plurality of associated or paired apparatuses. For example, such a personal network may comprise a user's smartphone, smartwatch and digital assistant, all being associated and registered with a common user or user account, and interconnecting via wired or wireless protocols, such as WiFi, Bluetooth or the like. Example embodiments achieve this in a computationally-feasible way and scalable way, in the sense that an existing model can be scaled-up to cater for a greater number of users and/or classes.

In overview, example embodiments may involve providing a first model for classifying first input data to one of a first number of classes, and receiving user input indicative of one or more new classes to add to the first machine learning model. The user input may be received by any suitable means, such as through a user interface or through a voice command or haptic input. Second input data may be received for allocating to the or each new class and the first machine learning model may be adapted or augmented to provide a second machine learning model by adding the one or more new classes to the first number of classes. In some embodiments, a prior probability distribution for the second machine learning model may be determined, based on (i) a first posterior probability distribution learned for the first number of classes, and (ii) one or more outputs generated by the second learning model responsive to receiving the first input data. The second machine learning model may be updated by means of applying the first and second input data as training data.

Example embodiments are given in terms of models that act on audio or movement data, which may be termed sensory data, but are not limited to such. As mentioned, such data may be generated at the apparatus implementing the model or may be received from one or more other apparatuses that form part of a personal network associated with a common user or group of users that feed data to the apparatus implementing the model. In some embodiments, multiple such apparatuses may implement the model in a distributed way.

Example embodiments provide a means to update such models in a way that is both private, and self-sufficient. Privacy comes from not requiring users to share private data with external providers of models or training data; embodiments enable such data to be kept securely within their apparatus or personal area network (PAN) of associated apparatuses. This makes the embodiments particular suited to training models which use or are related to sensitive data, such as healthcare data or data relating to passwords etc. where the user will typically be hesitant or unwilling to share that data with external servers.

Example embodiments also enable updating an existing model without a significant reduction in performance of old classes which is undesirable.

The models referred to herein may be statistical models such as a Bayesian model. A Bayesian model is a probabilistic model which employs posterior inference. A prior statistical distribution, which represents some known or assumed knowledge about at least part of the model, is used and can be directly encoded as part of the model's hyper parameters (e.g. weights.) Data may be received when using the model and can be used to update the statistical distribution, which updated version is known as the posterior distribution. When further input data is received, the posterior distribution becomes the new prior distribution, and so on.

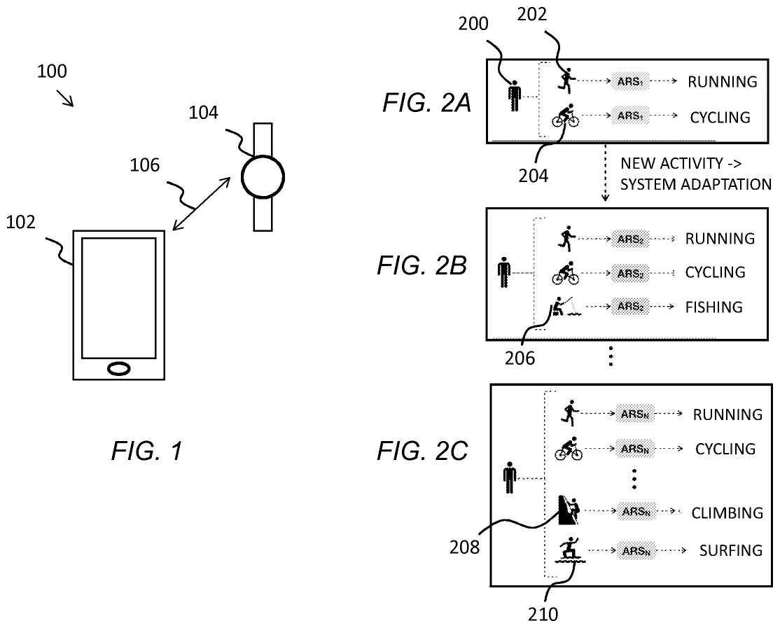

FIG. 1 is a schematic view of functional elements of a system 100 which may be configured with means for adapting a model according to one or more example embodiments. The system 100 may comprise one or more apparatuses, such one or more edge devices 102 and one or more peripheral devices 104, and in this example comprise a mobile communication device such as a smartphone 102 and a wearable device such as a smartwatch 104. The smartphone 102 and smartwatch 104 may be connected and/or paired through a wired or short range wireless communication link 106, such as using WiFi, Bluetooth®, ZigBee® or similar. The smartphone 102 and smartwatch 104 may be associated or registered with the same user or user account. Either or both the smartphone 102 and smartwatch 104 may comprise one or more sensors for generating input data, such as user input data, including, but not limited to, audio, video and motion data. For example, both the smartphone 102 and the smartwatch 104 may comprise one or more microphones, cameras, or motion sensors such as, but not limited to, gyroscopes and/or accelerometers. The input data, such as user input data, generated by said one or more sensors may be provided to a model for both training and inference generation. For example, the model may be provided on the smartphone 102 and may receive motion data over a Bluetooth link as input from one or more motion sensors on the smartwatch 104.

In additional or alternative example embodiments, the edge device 102 may be, e.g., a server device, a network access point, a router, and the peripheral device 104 may be, e.g., an IoT (Internet of Things) device comprising one or more sensors. In another additional or alternative example embodiments, the edge device 102 may be, e.g., a vehicle, and the peripheral device 104 may be, e.g., a sensor device in or embedded in the vehicle and/or external to the vehicle Further, the one or more edge devices 102 and the one or more peripheral devices 104 may be connected and/or paired over a wireless telecommunication network/protocol, such as a 4G, 5G or any further generation technology, or any IoT communication network/protocol such as Low-Power Wide-Aarea

Networking (LPWAN), such as LoRaWANTM (Long Range Wide Area Network), Sigfox, NB-IoT (Narrowband Internet of Things), or similar.

In additional or alternative example embodiments, either or both the one or more edge devices 102 and one or more peripheral devices 104 may comprise one or more hardware (HW) components, that additionally or alternatively of the one or more sensors can generate input data, such as one or more HW input data, relating to functions and/or measurements of the one or more HW components, such as power/battery level, computer processor functions, radio transmitter/receiver functions, application status, application error status, etc. or any combination thereof.

In additional or alternative example embodiments, either or both the one or more edge devices 102 and one or more peripheral devices 104 may comprise one or more software applications, that additionally or alternatively of the one or more sensors and/or the one or more HW components can generate input data, such as one or more application input data, relating to functions and/or measurements of the one or more sensors and/or HW components, and/or relating to functions and/or measurements of internal processes of the edge device 102 and/or peripheral devices 104, such as power/battery level, computer processor functions, radio transmitter/receiver functions, application status, application error status, etc. or any combination thereof.

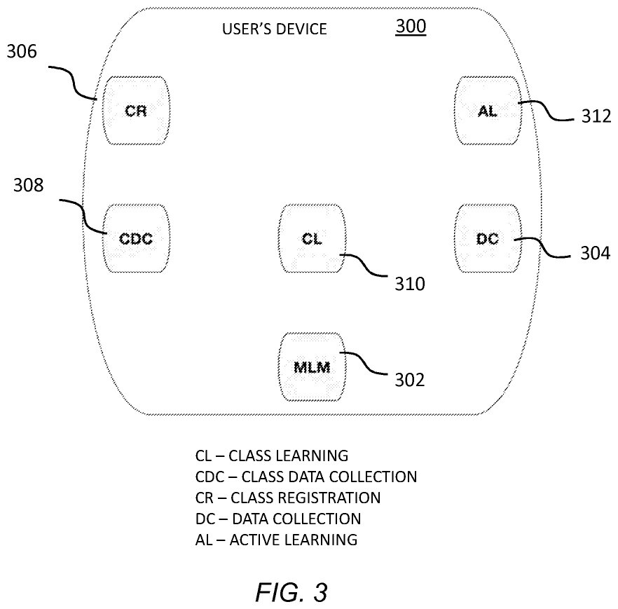

The received motion data may be classified by a trained/current model as one of a plurality of labelled classifications, as indicated in FIG. 2A. For example, for a particular user 200, the motion data may be classified as either a running class 202 0r a cycling class 204. Depending on the determined class, further processing may be performed on the data using a fitness application, for example to indicate parameters such as calories burned, distance travelled and so on, and said parameters may be used as part of an overall activity or health summary that collects over time.

FIGS. 2B and 2C indicate a scenario in which example embodiments may be used. In FIGS. 2B and 2C the user 200 may wish to add one or more further/new activity classes 206, 208, 210 to the same trained model to cater for one or more further activities they may wish to perform but without the need to download one or more new models or share input data for the new classes outside of the personal area network.

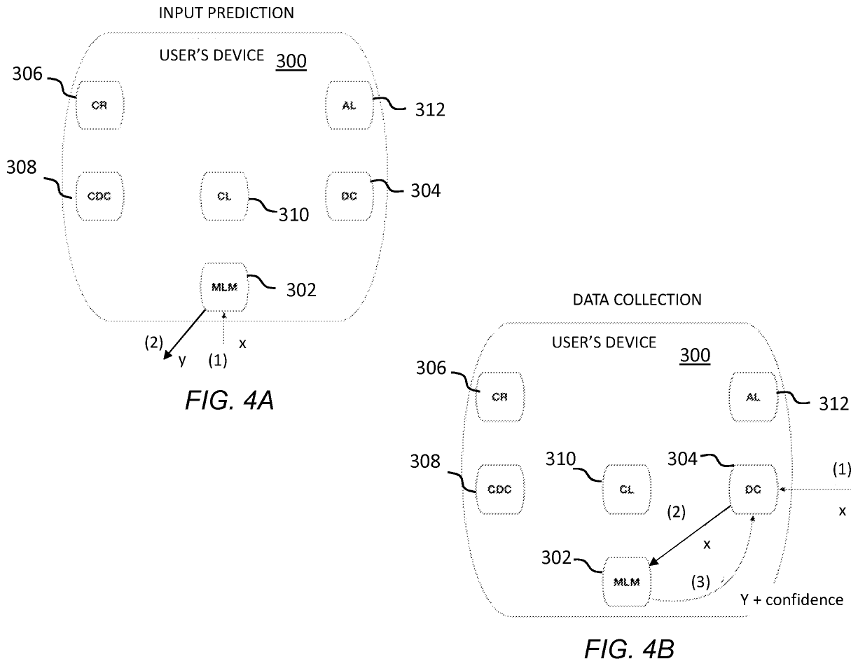

Referring now to FIG. 3, a functional diagram of an apparatus 300 according to one example embodiment is shown. The apparatus 300 comprises one or more machine learning model components (MLM) 302, and functional modules for interaction with the MLM component, including a data collection (DC) component 304, a class registration (CR) component 306, a class data collection (CDC) component 308, a class learning (CL) component 310, and, optionally, an active learning (AL) component 312.

Each of the components 302-312 may comprise computer-readable code stored on a computer-readable medium which, when executed by one or more processors or controllers, performs operations described herein. One or more of the components 302-312 may be provided as a single or multiple files or as part of an application having distinct functions.

When the functional modules are first deployed, the apparatus 300 may proceed through a setup phase, described below.

Setup Phase

The MLM component 302 may consist of a model, such as a trained model, that is updated over time as a user inputs or “registers” one or more new tasks. The MLM component 302 may also comprise an API or similar to handle the input of data into an input layer of the model, the output data from an output layer of the model, and adaptation of the model based on interaction with the one or more other components shown in FIG. 3. During setup, the user may download the MLM component 302, 0r the model to the MLM component, which may support a number of predefined classes (e.g. different keywords for keyword spotting, or different activates for activity recognition.) In some embodiments, this is the only operation requiring communication with external resources (i.e. downloading the MLM component 302 and/or the model from a server). All subsequent operations may be performed using the apparatus 300 0r the apparatus in conjunction with other apparatuses within the user's personal area network mentioned above.

Use Phase

The MLM component 302 may be used for input classification/prediction. That is, during an input prediction phase, the apparatus 300 may, by means of its sensors, provide input data, such as user input data, to the MLM component 302 which may then provide said user input data to the model and return a predicted output class, e.g. cycling.

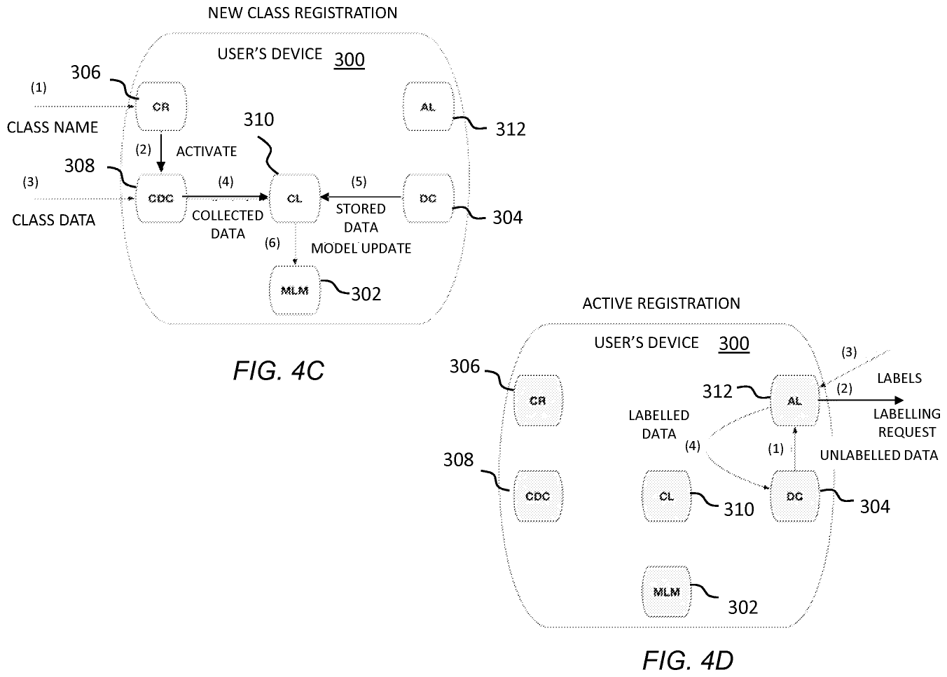

This phase of operation is indicated in FIG. 4A whereby in a first operation (1) user input data “x” is applied to the MLM component 302 which then returns in a second operation (2) the predicted class “y”. In order to avoid false positives, when provided with a new input “x”, the MLM component 302 0nly outputs the predicted label “y” if a confidence estimate on this prediction is above a predefined threshold. Confidence estimates may be obtained by repeatedly running the model on the user input data “x” and observing the variation on the predicted label output “y”, with lower variation implying a higher confidence.

Referring now to FIG. 4B, the DC component 304 is configured to receive and collect input data, such as user input data and/or sensor data, over time, in a continuous or periodic manner, with or without the user's prior permission, which may be granted through configuration settings associated with the apparatus 300. In a first operation (1) of its processing, the DC component 304 passes the incoming input data “x” to the MLM component 302 which, in a second operation (2), generates a predicted label “y” in the same way as described above and passes this data back to the DC component in an operation (3).

The DC component 304 may then be configured to store the data “x” and “y” in accordance with the following example strategy.

Firstly, if the probability of the prediction is above a predetermined threshold “T”, then the DC component 304 may store the input and corresponding output data pair (x, y) on memory of the apparatus 300, 0r indeed any storage component within the user's personal area network, as ‘labelled recorded data.’ Note that the value of “y” may be incorrect, as it is a prediction generated by the model in the MLM component 302 and is not labelled by the user.

Otherwise, if the probability is at or below the predetermined threshold “T”, the DC component 304 may be configured to store only the value of “x” on the memory of the apparatus 300, 0r another storage component within the user's personal area network, as ‘unlabelled recorded data’. Still in alternative implementation, the DC component 304 may store the input (x), the corresponding output data (y) and the corresponding probability (p) vector (x, y, p) on the memory of the apparatus 300

The number of input data values “x”, generally user-generated data samples, such as sensor generated data, supplied to the DC component 304 need only be a relatively small number.

At this stage, it is worth noting that user-generated data “x”, “y” and “p” are received, processed and stored only on the apparatus 300 and/or the user's personal area network, so as to efficiently leverage user data, whilst preserving privacy.

Referring now to FIG. 4C, a user may indicate that the existing model in the MLM component 302 is to be adapted to add one or more new classes. This may be initiated through any input or command means, such as through one or more a voice command, touch input via a user interface or haptic input using the apparatus 300 0r another apparatus of the personal area network.

The CR component 306 may be configured to be enabled in response to user initiation of a model adaptation. In a first operation (1), the user may indicate the name of the new class to the CR component 306. The user may then indicate that they will start providing new input data for that new class, e.g. by speaking a new word or words, and/or performing a new activity, wherein the input data is provided by one or more sensors, depending on the nature of the new class. For example, a user interface associated with the apparatus 300 may present a timer indicating that the user should start providing the new input data after a certain number of seconds. Alternatively, the user may initiate the process by selecting a ‘start’ option or the like. The CR component 306 may at this stage be configured to perform a second operation (2) of activating the CDC component 308.

The CDC component 308 may commence receiving the new input data in a third operation (3). The CDC component 308 may record the incoming new input data, and in a fourth operation (4), the CL may be configured to label every received data point x with the new class label specified by the user in the first operation (1). In practice, it may be the case that the new input data is imperfect (e.g. the user may get interrupted when performing the new activity) which implies that not all new data points “x” will correspond to the new class. Example embodiments are robust to these kinds of issues (i.e., tolerant to some of the new input data not actually being from the new class). Thus, the CDC component 308 may not require the user to restart data collection due to potentially irrelevant input data.

Data may be collected in this way until the user explicitly indicates that they have finished new data provision, which may be via a command to the CR component 306, 0r if no new data is received for a predetermined time period.

Once the user indicates to the CR component 306 that new data provision, such as new data distribution, is finished, the model of the MLM component 302 may commence adaptation by extension of its existing set of classes to include the new registered class. The CL component 310 is then configured to make use of the following learning approaches.

A first approach may be termed Bayesian continued learning (BCL). BCL involves learning a posterior distribution over the new data distribution, and then updating the current model prior to match the learned posterior. This process makes use of both the new input data for the new class, i.e. the new data distribution, recorded by the CDC component 308 and sent to the CL component 310 in a fourth operation (4), as well as, in a fifth operation (5), using the previously-mentioned labeled recorded data for other classes, recorded and stored during the data collection step by the DC component 304.

A second approach, which may follow the first approach, may involve unsupervised learning. This second approach may use the unlabeled data recorded by the DC component 304 (5) to improve predictive performance of the system on all classes (including the new introduced class) and reducing the amount of data for the new class that the user has to provide during the registration step.

The CL component 310 may make use of both the first and second approaches above to incorporate the new class data successfully and update the model of the MLM component 302 in a sixth operation (6), without losing performance on old classes registered previously. That is, a trained and operational adapted model is provided and can be used by the particular user.

A more detailed explanation, including the use of mathematical notation, now follows.

A brief summary of some of the notation relevant for the present description is presented below in Table 1.

TABLE 1
Notation

| Component | Notation |
|---|---|
| Input data recorded by CDC component 308 | x |
| Previously recorded labelled data | [symbol] _{0:i-1} := |
| | {(x, y): y being an |
| | existing label} |
| Previously recorded labelled data stored in DC | [symbol] (D_{0:i-1}) ⊂ [symbol] _{0:i-1} |
| component 304 | |
| Model parameters | θ |
| Prior distribution of model parameters | p(θ\| [symbol] _{0:i-1}) |
| Probability of input x being in class y, estimated by | [fᵢ₋₁(x\|θ)]_{y,1} |
| existing model | |
| Parameters of surrogate posterior distribution | ϕᵢ |
| Learned parameters of previous surrogate posterior | ϕ^{*}ᵢ₋₁ |
| distribution | |
| Surrogate posterior distribution | qᵢ(θ\|ϕᵢ) |

The subscript i in the notation above refers to the number of times a user has initiated the adaptation of an original model f₀ by this procedure.

As described above, a first approach to adapting machine learning models may be referred to as Bayesian Continual Learning (BCL). More formally, adapting a trained model to extend the label space involves learning a model for p(y|x, [symbol] _{0:i}) for x ∈ X, where datasets [symbol] ₀, . . . , [symbol] ᵢ₋₁; [symbol] ⱼ={(x,y):y ∈ [symbol] ⱼ} are labelled datasets previously recorded by the DC component 304, and [symbol] ᵢ is the new data recorded by the CDC component 308.

Example embodiments allow for adapting machine learning models with a substantially smaller dataset [symbol] ( [symbol] _{0:i-1}) than the corresponding complete dataset [symbol] _{0:i-1}. For example, example embodiments may allow for the usage of 5 to 10% of the complete dataset, while maintaining overall performance benefits. This has advantages in reducing overall training time, reducing the amount of storage required to store the training data, and also enabling efficient training in a larger number of devices with varying degrees of computational power. As such, either the full datasets [symbol] _{0:i-1} or the substantially smaller datasets [symbol] ( [symbol] _{0:i-1}) (or coreset) may be stored at the DC component 304.

The model for p(y|x, [symbol] _{0:i}) is learned using the existing trained model for p(y|x,D_{0:i-1}) stored in the MLM component 302, which may have been learned using the methods described in the present description or otherwise. In addition, when adapting the model, the CL component 310 makes use of previously recorded data [symbol] ( [symbol] _{0:i-1}) stored in the DC component 304, as well as the newly recorded data [symbol] ᵢ stored in the CDC component 308, in response to the user initiating the class registration procedure.

The previously trained model is adapted to provide a second machine learning model by adding the one or more new classes to the first number of classes. For example, the previously trained model may be a neural network. In order to adapt the neural network to enable the classification of new classes, the weights and biases of the last layer, for example, can be adapted so as to generate additional outputs corresponding to the new classes. This may involve adding a number of columns to the weights of the last layer, and adding the same number of elements to the bias of the last layer. These additional elements may be initialised with distributions centred on zero. Alternatively, the machine learning model may be a decision tree, a support vector machine, or any other suitable machine learning model.

Prior and Posterior Models

In order to capture complex, high-dimensional sensory signals with an expressive model, the present description provides parameterizable prior distributions and multi-modal approximate (or surrogate) posterior distributions. The present description also enables continual learning even when the initial model is deterministic.

A prior probability distribution for the adapted machine learning model is set. This is based on (i) a first posterior probability distribution learned for the first number of classes, and (ii) one or more outputs generated by the adapted machine learning model responsive to receiving first input data. The first input data may be the coresets corresponding to the data collected for the first number of classes: (x, y) ∈ [symbol] ( [symbol] _{0:i-1}).

The prior distribution of the parameters may be a Gaussian distribution. The mean of the Gaussian distribution may be substantially the same as the mean of the surrogate posterior distribution learned for the first number of classes. This may be given by the following equation.

[symbol]

_{θ˜q}_{_{i−1}}(·|φᵢ₋₁_{^{*}}₎{θ} (1)

The covariance matrix of the Gaussian distribution may be provided by its inverse, namely a precision matrix. The precision matrix may comprise parameters based on derivatives of an expectation of the one or more outputs generated by the adapted machine learning model, responsive to receiving the first input data, wherein the expectation is with respect to the previously learned surrogate posterior probability distribution.

For input data in K dimensions and output data in Q dimensions, the parameters of the prior distribution may comprise K vectors, each parameter vector having Q dimensions: θ={w^{(k)}}ₖ₌₁^{K}; w^{(k)}∈ [symbol] ^{Q×1}. When augmenting the model, the precision matrix ψ_{0:i-1}^{(k)} for each parameter vector may be based on scalable approximations to the expected value of the Hessian of the negative log likelihood. Prior distributions may be determined so as to take into account the previous surrogate posterior and small coresets of previously seen datasets [symbol] ( [symbol] _{0:i-1}). For example, each ψ_{0:i-1}^{(k)} may be defined by a Hessian of the following function.

$$ϵ ↦ {𝔼}_{θ ∼ {q}_{i - 1} ( \cdot \vert {ϕ}_{i - 1}^{*} )} \{ - \frac{{( {D}_{0 : i - 1} )}_{} {log [ {f}_{i} ( x \vert θ + ϵ ) ]}_{y , 1}}{( {D}_{0 : i - 1} ) \vert} \} \qquad ( 2 )$$

In many cases, the true posterior distribution of the model parameters may be intractable, and so a surrogate posterior may be provided. The surrogate posterior may be defined by a generative process. The surrogate posterior distribution may comprise a product of mixtures of Gaussian distributions, each Gaussian distribution having the same covariance matrix.

For example, the following random variables may first be forward sampled:

z ∈{0, 1}^{K×1}; [z]_{k,1}:=Bernoulli (·|κ)

E:=[e⁽¹⁾, . . . , e^{(K)}]^{T}, e^{(k)}:= [symbol] (·|0, σ²I_{Q})

with κ ∈ [0,1] and σ>0.

The parameters of the surrogate posterior distribution are trainable and are learned by the machine learning model. These parameters may be represented as:

ϕᵢ:=Mᵢ:=[mᵢ⁽¹⁾, . . . , mᵢ^{(k)}]^{T} ∈ [symbol] ^{K×Q} (3)

When the machine learning model is a neural network with dense layers, the generative process of the surrogate posterior distribution may therefore be defined as:

Wᵢ:=diag(z)(Mᵢ+E)+diag(1−z)E (4)

with output xWᵢ+b, where b is deterministic and trainable.

A similar generative process can be defined for convolutional layers in neural networks.

Loss Functions

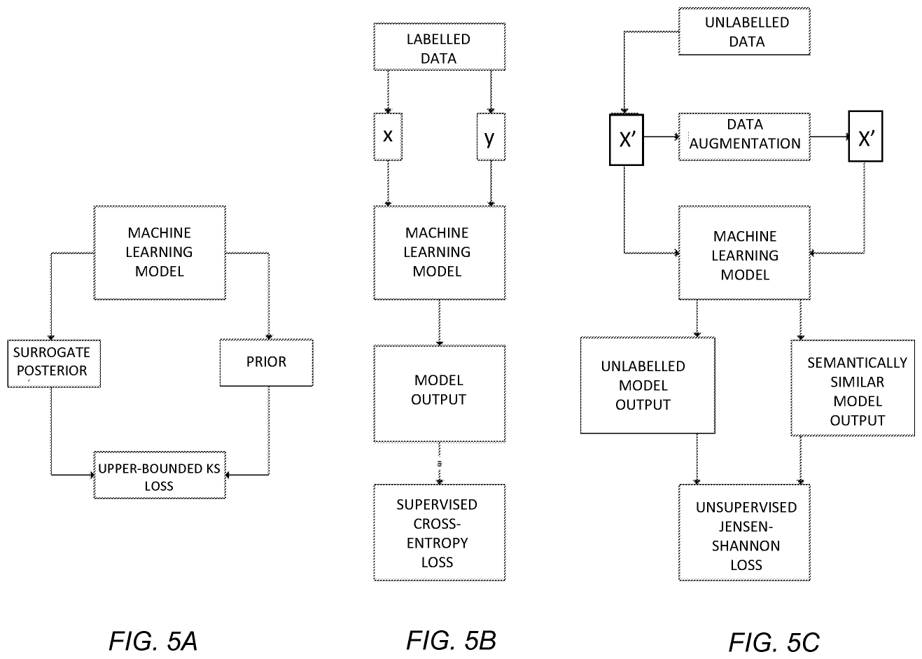

Referring now to FIGS. 5A, 5B, and 5C as example embodiments, the machine learning model is trained using a gradient optimisation procedure (e.g. backpropagation) in accordance with a loss function. The loss function may comprise supervised losses and/or unsupervised losses.

As indicated in FIGS. 5A and 5B, the supervised loss may be based on an upper bound of a divergence between the prior distribution and the surrogate posterior distribution. In this way, the surrogate posterior may be constrained to the tractable prior distribution. Additionally, minimising an upper bound of a divergence avoids the computational costs in relation to approximating the divergence through methods such as sampling. This enables efficient learning of the model in devices with varying degrees of computational power, allowing the model to be trained locally whilst preserving a user's privacy.

For example, the divergence of the supervised loss may be a KL divergence. When, for example, the machine learning model is a neural network with dense layers, the forms of the prior and surrogate posterior as described above allow for the minimization of the KL divergence through the following upper bound:

$$KL ( {q}_{i} ( \cdot \vert {M}_{i} ) ‖ p ( \cdot \vert {𝒟}_{0 : i - 1} ) ) \leq \qquad ( 5 )$$

$${\sum }_{k = 1}^{K} ( \begin{matrix}κlog ( κ𝒩 ( 0 \vert 0 , 2 {σ}^{2} {I}_{Q} ) + ( 1 - κ ) 𝒩 ( {m}_{i}^{( k )} \vert 0 , 2 {σ}^{2} {I}_{Q} ) ) + \\ ( 1 - κ ) log ( κ𝒩 ( {m}_{i}^{( k )} \vert 0 , 2 {σ}^{2} {I}_{Q} ) + ( 1 - κ ) 𝒩 ( 0 \vert 0 , 2 {σ}^{2} {I}_{Q} ) ) + \\ \frac{1}{2} ( log ( 2 π \vert {{Ψ}_{0 : i - 1}^{( k )}}^{- 1} \vert ) + tr ( {σ}^{2} {Ψ}_{0 : i - 1}^{( k )} ) ) + \\ \frac{κ}{2} {( {m}_{i}^{( k )} - {m}_{i - 1}^{( k ) *} )}^{T} {Ψ}_{0 : i - 1}^{( k )} ( {m}_{i}^{( k )} - {m}_{i - 1}^{( k ) *} ) + \\ \frac{κ ( 1 - κ )}{2} {m}_{i - 1}^{( k ) {*}^{T}} ( {Ψ}_{0 : i - 1}^{( k )} + {{Ψ}_{0 : i - 1}^{( k )}}^{T} ) ( {m}_{i}^{( k )} - {m}_{i - 1}^{( k ) *} ) + \\ \frac{κ ( 1 - κ )}{2} {{m}_{i - 1}^{( k ) *}}^{T} {Ψ}_{0 : i - 1}^{( k )} {m}_{i - 1}^{( k ) *}\end{matrix} )$$

where mᵢ₋₁^{(k)}* is the relevant mean of the previous surrogate posterior.

As indicated in FIG. 5C, the unsupervised loss may be based on an averaged divergence between model outputs of: (i) unlabelled data (and/or labelled data in the coreset [symbol] ( [symbol] _{0:i-1})) and (ii) data semantically related to the unlabelled data. This loss term constrains the model to produce similar outputs for similar inputs.

Data that is semantically similar can be obtained by modifying the unlabelled input data to produce closely related data. The semantically similar data may be obtained in different ways depending on the input data type. For example for sound data in the form of pulse-code modulation, modifications can include time stretching, pitch shifting and rotation transformations. For motion data, the modifications can include rotation and corruption of data by average feature values. Other modifications are possible depending on the data type and format. The modification of unlabelled data will be represented in the below by the function modify(x).

Augmenting the model using a loss function comprising an unsupervised loss term can greatly reduce the set up time required to support a new class, as substantially less labelled data is required to achieve a sufficient level of performance.

The divergence of the unsupervised loss may be a JS divergence. For example, the unsupervised loss may be given by:

Σ [symbol] _{θ˜q}_{_{i−1}}_{(·|ϕ}_{ᵢ}₎{JD(fᵢ(x|θ)∥fᵢ(modify(x)|θ))} (6)

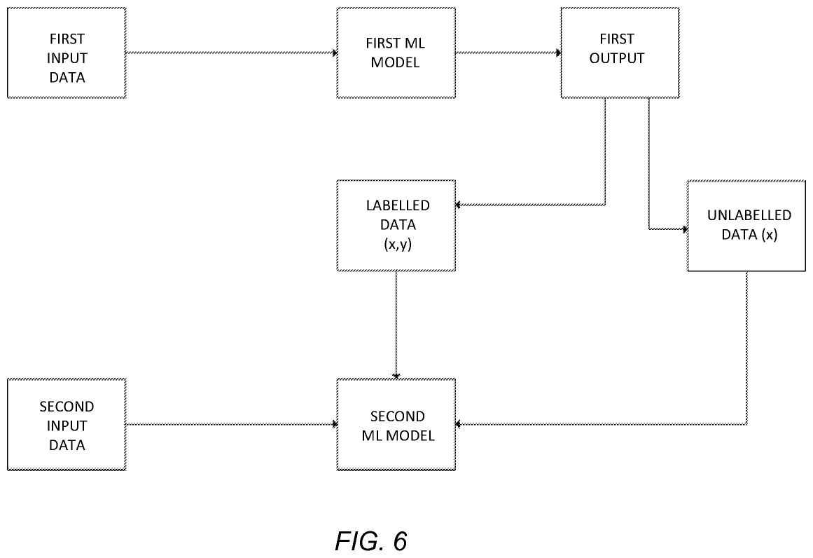

FIG. 6 is an overview of the general process disclosed in the present description.

Active Learning

In FIG. 4D an additional aspect of the invention, the AL component 312 may be configured to improve the training process for the adapted model. For example, the user may be given the option, e.g. through a one-off or periodic prompt via a user interface of the apparatus 300, to label a number of input data samples. For example, the number of input samples may be as low as 5-10 samples. If the user indicates their willingness, the AL component 312 may be initiated and may receive in a first operation (1) from the DC component some unlabelled data samples (mentioned above) already stored for the user. The AL component 312 may identify the most useful or promising unlabelled data samples that have the best chance of improving predictive performance of the model in the MLM component 302 if labelled The AL component 312 may be configured to prompt the user in a second operation (2) to label such selected candidate samples manually, e.g. “this sample corresponds to swimming.” The user may be prompted with selectable icons or the like for each available class and, in a third step (3), receives selection of one such class. In a fourth operation (4), the labelled samples are stored by the DC component 302 and used in updating the model in the MLM component 302.

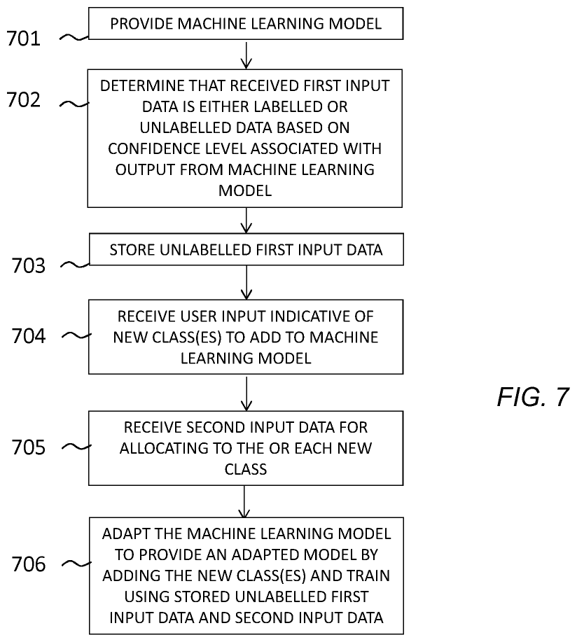

FIG. 7 is a flow diagram indicating processing operations that may be performed by one or more processors or controllers in conjunction with computer-readable code stored on non-transitory media. Alternatively, some or all operations may be performed in hardware, firmware or a combination thereof.

A first operation 701 may comprise providing a machine learning model. A second operation 702 may comprise determining that receive first input data is either labelled or unlabelled data based on a confidence level associated with output from the machine learning model. A third operation 703 may comprise storing the unlabelled first input data. A fourth operation 704 may comprise receiving user input indicative of new class(es) to add to the machine learning model. A fifth operation 705 may comprise receiving second input data for allocating to the or each new class. A sixth operation may comprise adapting the machine learning model to provide an adapted model by adding the new class(es) and by training the model using the stored unlabelled first input data and the second input data.

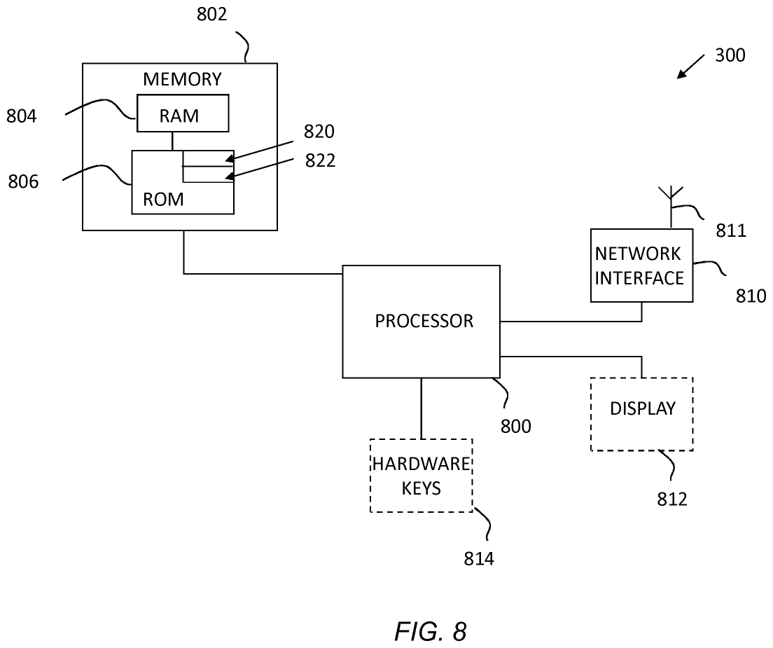

FIG. 8 is a functional block diagram that may comprise the apparatus 300, such as 102 0r 104, described herein, configured to perform the operations described herein, for example those described with reference to FIG. 7.

The apparatus 300 may have one or more processors 800, 0ne or more memories 802 closely-coupled to the one or more processors and comprised of a RAM 804 and ROM 806. The apparatus 300 may comprise one or more network interfaces 810, with one or more antennas 811, and optionally a display 812 and one or more hardware keys 814. The apparatus 300 may comprise one or more such network interfaces 810 for connection to a network, e.g. a radio access network. The one or more network interfaces 810 may also be for connection to the internet, e.g. using WiFi, Bluetooth or similar. The processor 300 is connected to each of the other components in order to control operation thereof. Further, the apparatus 300 may comprise one or more sensors, for example, microphones, cameras, motion sensors, gyroscopes, accelerometers, IMU's (Inertial Measurement Unit), thermometers, barometers, physiology measurement sensors, heart rate sensors, pedometers, GNSS (Global Navigation Satellite System) sensors, or any combination thereof.

The memory 802 may comprise a non-volatile memory, a hard disk drive (HDD) or a solid state drive (SSD). The ROM 806 0f the memory stores, amongst other things, an operating system 820 and may store one or more software applications 822. The RAM 804 0f the memory 802 may be used by the processor 800 for the temporary storage of data. The operating system 820 may contain code which, when executed by the processor, implements the operations as described below, for example in the flow diagram. Alternatively, or additionally, one or more of the software applications 822 may comprise means for performing the operations described above.

The processor 800 may take any suitable form. For instance, the processor 800 may be a circuit, a microcontroller, plural microcontrollers, a microprocessor, a CPU (Central Processing Unit), one or more processing cores, a GPU (Graphics Processing Unit), a NPU (Neural processing Unit) or plural microprocessors and the processor may comprise processor circuitry.

As used in this application, the term “circuitry” may refer to one or more or all of the following:

(a) hardware-only circuit implementations (such as implementations in only analog and/or digital circuitry);

(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions); and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As described herein, the memory 602 may be volatile or non-volatile. It may be e.g. a RAM, a SRAM, a flash memory, a FPGA block ram, a DCD, a CD, a USB stick, and a blue ray disk.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof. Some embodiments may be implemented in the cloud.

It is to be understood that what is described above is what is presently considered the preferred embodiments. However, it should be noted that the description of the preferred embodiments is given by way of example only and that various modifications may be made without departing from the scope as defined by the appended claims.

1-32. (canceled)

33. An apparatus comprising: at least one processor, and at least one memory storing instructions which, when executed by the at least one processor, causes the apparatus at least to;
provide a first machine learning model for classifying first input data to one of a first number of classes;
receive an input indicative of one or more new classes to add to the first machine learning model;
receive second input data for allocating to the one or more, or each new classes;
adapt the first machine learning model to provide a second machine learning model by adding the one or more new classes to the first number of classes;
train the second machine learning model using the first input data and the second input data.

34. The apparatus of claim 33, wherein the adapting of the first machine learning model further causes the apparatus to set a prior probability distribution for the second machine learning model based on (i) a first posterior probability distribution learned for the first number of classes, and (ii) one or more outputs generated by the second machine learning model responsive to receiving the first input data; and update the second machine learning model by apply the first input data and the second input data as training data.

35. The apparatus of claim 34, wherein the setting of the prior probability distribution for the second machine learning model further causes the apparatus to provide a Gaussian probability distribution with: (i) a mean substantially equal to the mean of the first posterior probability distribution, and (ii) a precision matrix.

36. The apparatus of claim 35, wherein the precision matrix comprises parameters based on derivatives of an expectation of the one or more outputs generated by the second machine learning model, wherein the expectation is with respect to the first posterior probability distribution.

37. The apparatus of claim 36, wherein the adapting of the first machine learning model further causes the apparatus to:
provide a second posterior distribution, wherein the second posterior distribution comprises a product of mixtures of Gaussian distributions, each Gaussian distribution having the same covariance matrix; and
train the second machine learning model based on a loss function comprising a supervised loss, wherein the supervised loss minimises an upper bound of a divergence between the prior distribution and the second posterior distribution.

38. The apparatus of claim 33, wherein the instructions which, when executed by the at least one processor, further causes the apparatus to:
determine that received first input data is either labelled or unlabelled data based on a confidence level associated with the resulting output from its application to the first machine learning model; and
store the unlabelled first input data.

39. The apparatus of claim 38, wherein the instructions which, when executed by the at least one processor, further causes the apparatus to:
receive user-labelling of at least a portion of the stored unlabelled first data as belonging to a particular class of the second machine learning model; and
adapt the second machine learning model by means of applying the user-labelled data to it as new training data.

40. The apparatus of claim 39, wherein the instructions which, when executed by the at least one processor, further causes the apparatus to prompt said user-labelling via a user-interface of the apparatus.

41. The apparatus of claim 39, wherein the instructions which, when executed by the at least one processor, further causes the apparatus to identify, from the stored unlabelled first data, a portion of said data having the highest likelihood of belonging to a particular class.

42. The apparatus of claim 38, wherein the adapting of the first machine learning model further causes the apparatus to receive one or more unlabelled data values from the stored unlabelled first data;
identify one or more semantically-similar data points to the one or more unlabelled data values;
apply the second machine learning model to (i) the one or more unlabelled data values to generate an unlabelled model output, and (ii) the identified one or more semantically-similar data points to generate a semantically-similar model output;
train the second machine learning model based on a loss function comprising an unsupervised training loss, wherein the unsupervised training loss is arranged to minimise an averaged divergence between: (i) the unlabelled model output, and (ii) the semantically-similar model output.

43. The apparatus of claim 33, wherein the first and second input data is generated by one or more sensors provided on said apparatus and/or on one or more user devices associated or paired with said apparatus as part of a personal network of an individual user.

44. The apparatus of claim 43, wherein one or more of said apparatus and/or the one or more user devices include wearable device(s).

45. The apparatus of claim 43, wherein none of the first and second input data is received externally from the apparatus and/or from the one or more user devices associated or paired with said apparatus as part of the personal network.

46. The apparatus of claim 33, wherein the first and second machine learning models are trained to classify input data representing user motion to one of a plurality of the different classes representing respective activities.

47. The apparatus of claim 33, wherein the first and second machine learning models are trained to classify input data representing audio to one of a plurality of the different classes representing users or commands.

48. A method, comprising:
providing a first machine learning model for classifying first input data to one of a first number of classes;
receiving an input indicative of one or more new classes to add to the first machine learning model;
receiving second input data for allocating to the one or more, or each new classes;
adapting the first machine learning model to provide a second machine learning model by adding the one or more new classes to the first number of classes;
training the second machine learning model using the first input data and the second input data.

49. The method of claim 48, wherein the adapting of the first machine learning model comprises setting a prior probability distribution for the second machine learning model based on (i) a first posterior probability distribution learned for the first number of classes, and (ii) one or more outputs generated by the second machine learning model responsive to receiving the first input data; and updating the second machine learning model by means of applying the first input data and the second input data as training data.

50. The method of claim 48, further comprising:
determining that received first input data is either labelled or unlabelled data based on a confidence level associated with the resulting output from its application to the first machine learning model; and
storing the unlabelled first input data.

51. The method of claim 48, wherein the first and second input data is generated by one or more sensors provided on said apparatus and/or on one or more user devices associated or paired with said apparatus as part of a personal network of an individual user.

52. A non-transitory computer-readable medium comprising program instructions stored thereon for performing at least the following:
providing a first machine learning model for classifying first input data to one of a first number of classes;
receiving an input indicative of one or more new classes to add to the first machine learning model;
receiving second input data for allocating to the one or more, or each new classes;
adapting the first machine learning model to provide a second machine learning model by adding the one or more new classes to the first number of classes;
training the second machine learning model using the first input data and the second input data.
